(19) United States
(12) Patent Application Publication
(10) Pub. No.: US 2020/0000066 A1
(43) Pub. Date: Jan. 2, 2020

(54) DOG LEASH AND IDENTIFICATION TAG

(71) Applicant: Sit Means Sit Dog Training., San Jose, CA (US)

(72) Inventor: Ryan TuHai Ngo, San Jose, CA (US)

(21) Appl. No.: 16/455,062

(22) Filed: Jun. 27, 2019

Related U.S. Application Data
(60) Provisional application No. 62/690,642, filed on Jun. 27, 2018.

(51) Int. Cl. A01K 27/00

(52) U.S. Cl. CPC A01K 27/006; A01K 27/001; A01K 27/003; A01K 27/005

(57) ABSTRACT

Embodiments of a dog leash are provided herein. In some embodiments, a dog leash includes a strap having a collar end and a handle end, a strap buckle connected to the collar end, a collar buckle having a central channel and an opening at an end of the central channel, wherein the opening is configured to retain a metal ring, and a tag having a first recess on a first side and a second recess on a second side, wherein the first recess is capable of retaining the strap buckle to connect the strap buckle to the tag, and wherein the second recess is capable of retaining the collar buckle to connect the collar buckle to the tag.

### CROSS-REFERENCE TO RELATED APPLICATIONS

This application claims benefit of U.S. provisional patent application Ser. No. 62/690,642, filed Jun. 27, 2018, which is herein incorporated by reference in its entirety.

### FIELD

Embodiments of the present disclosure generally relate to a dog leash.

### BACKGROUND

Leashes are used to restrain or control the neck or head of an animal, such as a dog. Leashes are often made of a strap of material attached to a metal snap hook at one end of the leash. A collar goes around the neck or head of the dog and is generally connected to a metal ring, such as a “D” ring. The metal snap hook of the leash can connect to the metal ring to connect the leash to the collar. The metal snap hook may often be difficult to attach to the metal ring, especially when used by a person with physical limitations or when dealing with a restless dog.

Identification tags are often used with dog collars to provide identifying information regarding the dog. Identification tags typically include a metal ring, such as a keychain ring, that connects to the metal ring of the collar.

Accordingly, the inventors have provided an improved dog leash that connects to a dog collar and provides identifying information regarding the dog.

### SUMMARY

Embodiments of a dog leash are provided herein. In some embodiments, a dog tag includes a tag having a buckle portion and a front portion, wherein the buckle portion includes a first recess on a first side and a second recess on a second side, wherein the first recess is capable of retaining a strap buckle and the second recess is capable of retaining a collar buckle, and wherein the front portion includes a front surface.

In some embodiments, a dog leash includes a strap having a collar end and a handle end, a strap buckle coupled to the collar end, a collar buckle having a central channel and an opening at an end of the central channel, wherein the opening is configured to retain a ring, and a tag having a first recess on a first side and a second recess on a second side, wherein the first recess is capable of retaining the strap buckle to connect the strap buckle to the tag, and wherein the second recess is capable of retaining the collar buckle to connect the collar buckle to the tag.

In some embodiments, a dog leash includes a strap having a collar end and a handle end; a strap buckle coupled to the collar end; a collar buckle having an opening; a collar having a metal ring, wherein the metal ring is disposed in the opening of the collar buckle; and a tag removeably coupled to the strap buckle at a first side and removeably coupled to the collar buckle at a second side.

Other and further embodiments of the present disclosure are described below.

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. However, the appended drawings illustrate only typical embodiments of the disclosure and are therefore not to be considered limiting of scope, for the disclosure may admit to other equally effective embodiments.

FIG. 1 is a schematic view of a dog leash in accordance with some embodiments of the present disclosure.

FIG. 2a is a top isometric view of a tag in accordance with some embodiments of the present disclosure.

FIG. 2b is a rear isometric view of the tag of FIG. 2a.

FIG. 3 depicts a collar buckle in accordance with some embodiments of the present disclosure.

FIG. 4 depicts a strap buckle in accordance with some embodiments of the present disclosure.

FIG. 5 depicts a locking device in accordance with some embodiments of the present disclosure.

FIG. 6 is a schematic view of a dog leash in accordance with some embodiments of the present disclosure.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

Embodiments of a dog leash are provided herein. The disclosure refers to a dog leash as a means to restrain and identify a dog, but it should be appreciated that the dog leash described in the present disclosure can be used as a means to restrain and identify other types of animals. Embodiments of the dog leash provided herein advantageously combines a simplified fastener and an identification tag. In addition, embodiments of the dog leash described herein can be custom designed. Embodiments of the dog leash can also easily be manufactured via a 3-D printer.

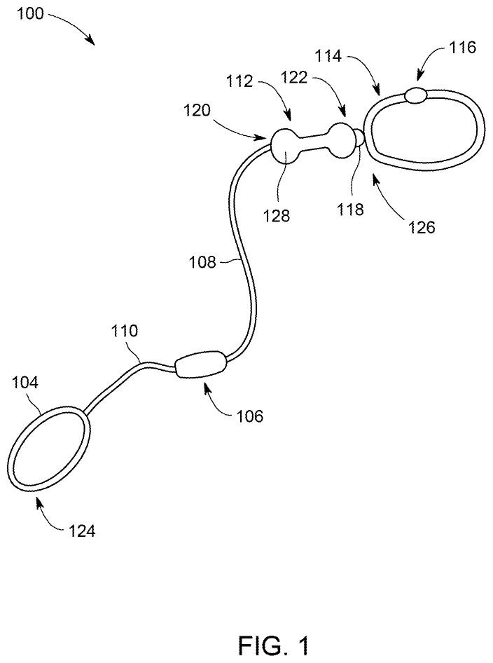

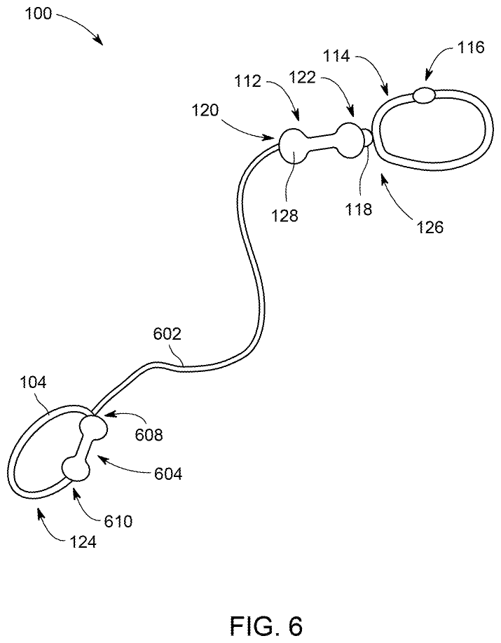

FIG. 1 is a schematic view of a dog leash in accordance with some embodiments of the present disclosure. A dog leash 100 includes a first strap 108 and a second strap 110. The first strap 108 and the second strap 110 may be made from woven nylon, leather, rubber, a metal chain or the like. In some embodiments, the first strap 108 and the second strap 110 may be a single strap (e.g., as shown in FIG. 6). In some embodiments, the first strap 108 is connected to the second strap 110 via a locking device 106. In some embodiments, the first strap 108 is longer than the second strap 110.

The dog leash 100 has a handle end 124 and a collar end 126 having a collar 114. In some embodiments, the collar 114 includes a collar lock 116 such as a release buckle, a tongue buckle or the like to secure the collar 114 around a neck of a dog. The collar 114 includes a ring 118 such as a metal “O” ring or “D” ring. The collar 114 can be removeably secured to the collar end 126 of the dog leash 100 via the ring 118.

The dog leash 100 further includes a tag 112 disposed at the collar end 126. The tag 112 includes a first side 120 and a second side 122. The first side 120 of the tag 112 is capable of being removeably coupled to the first strap. The second side 122 of the tag 112 is capable of being removeably coupled to the ring 118. The tag 112 includes a front surface 128 that is shaped as a bone. The front surface 128 is capable of displaying identifying information of a dog such as name, address, phone number or the like. As such, the tag 112 may act as both a fastener and an identification tag. While the tag 112 is depicted as having a bone shape in FIG. 1, the tag 112 can be any suitable shape.

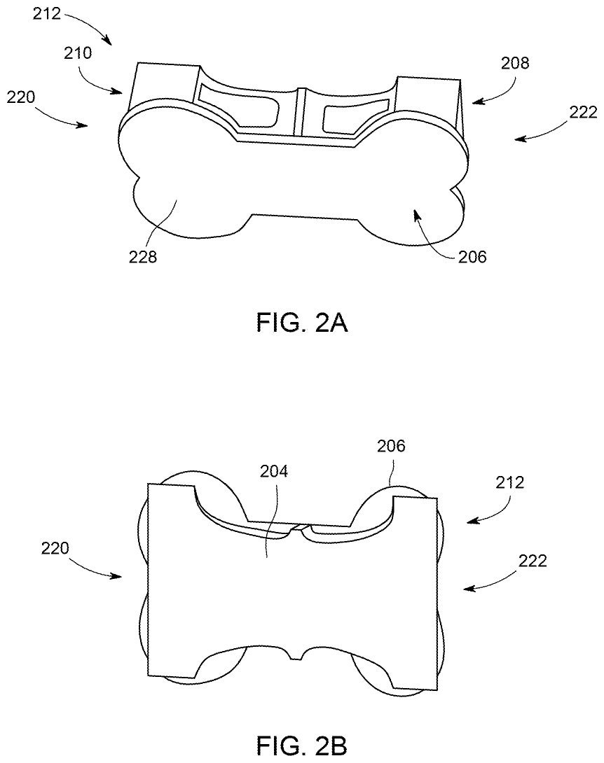

FIG. 2a is a top isometric view and FIG. 2b is a rear isometric view of a tag in accordance with some embodiments of the present disclosure. The tag 212 includes a buckle portion 204 and a front portion 206. The tag 212 may be made of plastic, aluminum, steel, or the like. The tag 212 may be made of a single structure that can be 3-D printed. Alternatively, the tag 212 may be made up of multiple components of the same material or different materials. The front portion 206 includes a front surface 228 that is capable of displaying identifying information. The buckle portion 204 includes a first recess 210 on a first side 220 and a second recess 208 on a second side 222. The first recess 210 is capable of engaging with a strap buckle (described below) connected to the first strap 108 to releasably fasten the tag 212 to the first strap 108. The second recess 208 is capable of engaging with a collar buckle (described below) connected to the collar 114 to releasably fasten the tag 212 to the collar 114.

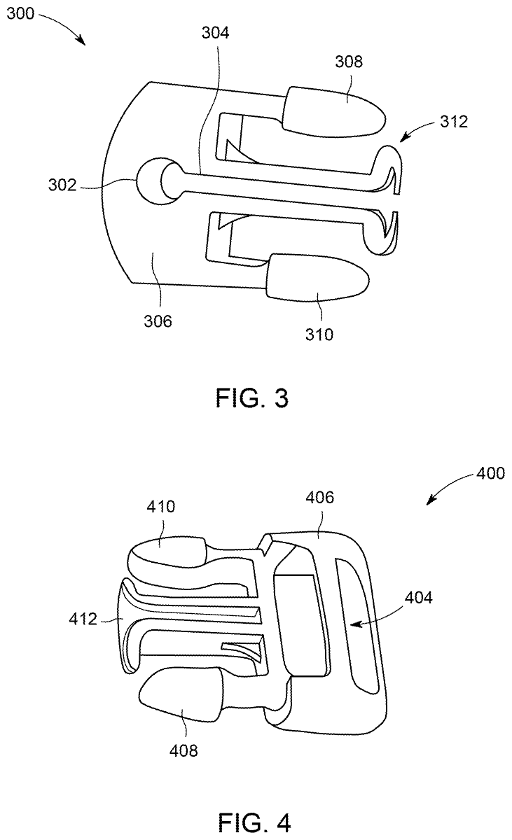

FIG. 3 depicts a collar buckle 300 in accordance with some embodiments of the present disclosure. The collar buckle 300 includes a main body 306 and a central tab 312 extending from the main body 306. The main body further includes a first tab 308 and a second tab 310, where both the first tab 308 and the second tab 310 extend from the main body 306 on either side of the central tab 312. The central tab 312 forms a channel 304 from an end of the central tab 312 towards the main body 306. The channel 304 is sized to allow the ring 118 of the collar 114 to pass through. The central tab 312 includes an opening 302 at an end of the channel 304 that is closer to the main body 306. The opening 302 has a diameter that is slightly larger than a width of the channel 304 such that the ring 118 can pass through the channel 304 and be retained within the opening 302, securing the collar buckle 300 to the collar 114. In use, the first tab 308, the second tab 310, and the central tab 312 are capable of entering and being retained within the second recess 208 of the tag 212. When the first tab 308 and the second tab 310 are forced closer together, the collar buckle 300 can be released from the second recess 208 to separate the collar buckle 300 from the tag 212.

FIG. 4 depicts a strap buckle 400 in accordance with some embodiments of the present disclosure. The strap buckle 400 includes a main body 406 and a central tab 412 extending from the main body 406. The main body further includes a first tab 408 and a second tab 410, where both the first tab 408 and the second tab 410 extend from the main body 406 on either side of the central tab 412. The main body 406 includes an opening 404. The first strap 108 can be looped through opening 404 to fasten the first strap 108 to the strap buckle 400. In some embodiments, as shown in FIG. 4, the opening 404 is disposed through a first side of the strap buckle 400. In some embodiments, the opening 404 is disposed through the strap buckle 400 from the first side of the strap buckle 400 to a second side of the strap buckle 400. In use, the first tab 408, the second tab 410, and the central tab 412 are capable of entering and being retained within the first recess 210 of the tag 212. When the first tab 408 and the second tab 410 are forced closer together, the strap buckle 400 can be released from the first recess 210 to separate the strap buckle 400 form the tag 212.

Referring back to FIG. 1, in some embodiments, the second strap 110 includes a loop to form a handle 104 at the handle end 124. The handle 104 is sized appropriately for slipping a person's hand through to conveniently hold the dog leash 100. In some embodiments, the handle 104 is capable of advantageously being retained by the locking device 106. In use, the dog leash 100 can be secured to an object such as a tree or a pole by passing the handle around the object and securing the handle 104 with the locking device 106. In this manner, the dog leash can safely and easily be attached to an object. In some embodiments, the second strap 110 includes one or more buckles that, when coupled to the locking device 106, form the handle 104.

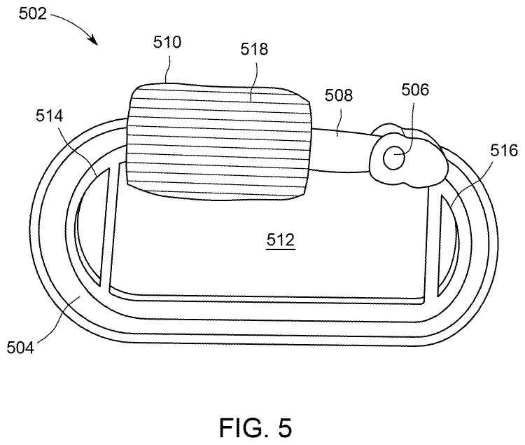

The locking device 106 can be a spring clip, a carabiner, a buckle or the like. The locking device 106 can be made of aluminum, steel, or the like. FIG. 5 shows a locking device in accordance with some embodiments of the present disclosure. Locking device 502 includes a link 504 having a generally oval shape to define a first volume 512. One side of the link 504 includes a gate 508 having a first end that may be pivoted inwards about a hinge 506. The hinge 506 may be spring loaded so that the gate 508 is normally closed. The gate 508 includes a nut 510 disposed near a second end. The nut 510 has a threaded central cavity. The link 504 includes a threaded portion adjacent the gate 508 that is configured to engage with the threaded central cavity of the nut 510 to secure the gate 508 to the link 504. The nut 510 may have grooves or other gripping features disposed on an outer surface 518 to assist a user in rotating the nut 510. The first strap 108 is capable of being secured to the link 504 via the first opening 514 and the second strap 110 is capable of being secured to the link 504 via the second opening 516, or vice versa. Alternatively, both the first strap 108 and the second strap 110 may be secured in one of the first opening 514 and the second opening 516. In use, the handle 104 or the collar 114 can be retained within the first volume 512 of the link 504.

FIG. 6 is a schematic view of a dog leash in accordance with some embodiments of the present disclosure. In some embodiments, locking device 604 is coupled to a strap 602. In some embodiments, the locking device 604 has a first recess on a first side and a second recess on a second side. In some embodiments, the strap 602 passes through an opening in the first buckle 608. The first buckle 608 may be coupled to the first side of the locking device 604 via the first recess. In some embodiments, the strap 602 is coupled to a second buckle 610. The second buckle may be coupled to the second side of the locking device 604 via the second recess to create the handle 104 from a portion of the strap 602 disposed between the first buckle 608 and the second buckle 610.

In some embodiments, the second buckle 610 is similar to the strap buckle 400. In some embodiments, the first buckle 608 is similar to the strap buckle 400. The opening in the first buckle 608 allows a loop forming the handle 104 to be adjustable in size. In use, the dog leash 100 can be secured to an object such as a tree or a pole by passing the strap 602 around the object and securing the strap 602 to the locking device 604 via the first buckle 608 and the second buckle 610. In this manner, the dog leash can safely and easily be attached to an object. In some embodiments, the locking device 604 is the same as the tag 212.

While the foregoing is directed to embodiments of the present disclosure, other and further embodiments of the disclosure may be devised without departing from the basic scope thereof.

1. A dog tag, comprising:
a tag having a buckle portion and a front portion, wherein the buckle portion includes a first recess on a first side and a second recess on a second side, wherein the first recess is capable of retaining a first buckle and the second recess is capable of retaining a second buckle, and wherein the front portion includes a front surface.

2. The dog tag of claim 1, wherein the front surface is shaped as a bone.

3. The dog tag of claim 1, wherein the front surface of the tag includes identifying information.

4. The dog tag of claim 3, wherein the identifying information includes at least one of a name, an address, or a phone number.

5. The dog tag of claim 1, wherein the tag is formed using 3-D printing processes.

6. The dog tag of claim 1, wherein the tag is made of plastic, aluminum, or steel.

7. A dog leash, comprising:
a strap having a collar end and a handle end;
a strap buckle coupled to the collar end;
a collar buckle having a central channel and an opening at an end of the central channel, wherein the opening is configured to retain a ring; and
a tag having a first recess on a first side and a second recess on a second side, wherein the first recess is capable of retaining the strap buckle to connect the strap buckle to the tag, and wherein the second recess is capable of retaining the collar buckle to connect the collar buckle to the tag.

8. The dog leash of claim 7, further comprising:
a locking device disposed on the dog leash between the collar end and the handle end, wherein the locking device is capable of retaining the handle end.

9. The dog leash of claim 8, further comprising a first buckle coupled to a first side of the locking device and a second buckle coupled to a second side of the locking device to create a handle at the handle end.

10. The dog leash of claim 8, wherein the locking device is one of a carabiner or a spring clip.

11. The dog leash of claim 8, wherein the locking device is a link having a gate with a first end that is connected to the link by a hinge and a second end that is capable of pivoting inwards about the hinge, wherein the gate includes a nut near the second end that is capable of engaging with a threaded portion of the link to lock the second end of the gate to the link.

12. The dog leash of claim 7, wherein the tag includes identifying information.

13. The dog leash of claim 7, wherein the collar buckle includes a first tab and a second tab, wherein both the first tab and the second tab 310 extend from a main body of the collar buckle on either side of a central tab.

14. The dog leash of claim 7, wherein the tag is made of plastic, aluminum, or steel.

15. The dog leash of claim 7, wherein the strap includes a handle at the handle end.

16. The dog leash of claim 15, wherein the strap includes a buckle to removeably attach the handle from a remainder of the strap.

17. A dog leash, comprising:
a strap having a collar end and a handle end;
a strap buckle coupled to the collar end;
a collar buckle having an opening;
a collar having a metal ring, wherein the metal ring is disposed in the opening of the collar buckle; and
a tag removeably coupled to the strap buckle at a first side and removeably coupled to the collar buckle at a second side.

18. The dog leash of claim 17, further comprising a first buckle having the strap pass therethrough, a second buckle coupled to the handle end, and a locking device, wherein the first buckle and the second buckle are coupled to the locking device to form a handle therebetween.

19. The dog leash of claim 17, wherein the collar buckle includes a main body and a central tab extending from the main body, wherein the central tab includes a channel extending from an end of the central tab towards the main body, and wherein the central tab includes an opening at an end of the channel closer to the main body.

20. The dog leash of claim 19, wherein the opening has a diameter that is slightly larger than a width of the channel to allow the metal ring to pass through the channel and be retained within the opening.
